(19) United States
(12) Patent Application Publication
(10) Pub. No.: US 2026/0362497 A1
(43) Pub. Date: Nov. 12, 2026

(54) USER EQUIPMENT (UE) TYPE ID FOR RANDOM ACCESS CHANNEL (RACH) PROCEDURES

(71) Applicant: QUALCOMM Incorporated, San Diego, CA (US)

(72) Inventors: Gokul SRIDHARAN, Sunnyvale, CA (US); Yeliz TOKGOZ, San Diego, CA (US); Krishna Kiran MUKKAVILLI, San Diego, CA (US); Linhai HE, San Diego, CA (US)

(21) Appl. No.: 19/201,713

(22) Filed: May 7, 2025

(51) Int. Cl. H04W 74/0833; H04L 5/00

(52) U.S. Cl. CPC H04W 74/0833; H04L 5/0023

(57) ABSTRACT

Techniques described herein introduce a user equipment type identifier (UTID), which may be linked to a user equipment (UE). This identifier may indicate a type of the UE (such as a smartphone, wearable, or other device) to a base station (BS) early in a connection process, including during initial access procedures, before a radio resource control (RRC) connection is established. By identifying the UE type upfront, the BS may tailor access handling to the specific UE type right from the start.

### BACKGROUND

### Field of the Disclosure

Aspects of the present disclosure relate to wireless communications, and more particularly, to techniques for managing identifiers (IDs) of a user equipment (UE) for random access channel (RACH) procedures.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes transmitting at least one UE type identifier (UTID) associated with the UE via a message during a random access channel (RACH) procedure to establish a connection between the UE and a network entity. The method further includes receiving radio configuration information for the UE. The radio configuration information is based on the at least one UTID.

Another aspect provides a method wireless communications at a network entity. The method includes receiving at least one UTID associated with a UE via a message during a RACH procedure to establish a connection between the UE and the network entity. The method further includes transmitting radio configuration information for the UE. The radio configuration information is based on the at least one UTID.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network, in accordance with certain aspects of the present disclosure.

FIG. 2 depicts an example disaggregated base station (BS) architecture, in accordance with certain aspects of the present disclosure.

FIG. 3 depicts aspects of an example BS and an example user equipment (UE), in accordance with certain aspects of the present disclosure.

FIG. 4A, FIG. 4B, FIG. 4C, and FIG. 4D depict various example aspects of data structures for a wireless communications network, in accordance with certain aspects of the present disclosure.

FIG. 5 depicts example four-step random access channel (RACH) procedure, in accordance with certain aspects of the present disclosure.

FIG. 6 depicts example two-step RACH procedure, in accordance with certain aspects of the present disclosure.

FIG. 7 depicts a call flow diagram that illustrates an example of communication between various wireless nodes, in accordance with certain aspects of the present disclosure.

FIG. 8 depicts a method for wireless communications at a UE, in accordance with certain aspects of the present disclosure.

FIG. 9 depicts a method for wireless communications at a network entity, in accordance with certain aspects of the present disclosure.

FIG. 10 and FIG. 11 depict example wireless nodes, in accordance with certain aspects of the present disclosure.

### DETAILED DESCRIPTION

A service profile identifier (SPID) generally refers to a unique identifier (e.g., a unique number) used in wireless networks to define the type of services (e.g., voice, data, etc.) that a particular user equipment (UE) is allowed to access or that the particular UE supports.

An SPID can assist a base station (BS) in identifying the type of UE connecting (e.g., a mobile phone, smart meter, or industrial sensor), enabling it to manage the connection appropriately. The SPID can also inform the BS of the services the UE is authorized to access such as enhanced mobile broadband, voice, and/or ultra-reliable low-latency communications. Additionally, the SPID supports the application of suitable quality of service (QoS) policies and radio configurations tailored to UE service requirements.

Different types of UEs may require different types of tailored handling even before establishing a full network connection (e.g., radio resource control (RRC) connected). For instance, one UE type may use simplified random access channel (RACH) procedures, while another might require dedicated RACH resources for lightweight, low-complexity access.

In conventional systems, SPIDs are only made available to the BS after the UE completes the RRC connection process. Likewise, the UE capability information used by the BS to determine the UE type is also inaccessible before the RRC connection. As a result, the BS lacks early visibility into the UE type, limiting its ability to optimize access procedures in advance.

Aspects of the present disclosure, however, introduces a new type of identifier (ID) for a UE, which may be shared with the BS before an RRC connection is established. This may enable the BS to recognize the UE type early, such as during initial access procedures, before the RRC connection is established. This early identification of the UE type may allow the BS to optimize access handling of the UE from the very beginning based on the specific UE type.

By functioning prior to the RRC connection setup, this new UE ID facilitates early-stage optimization, more efficient resource allocation, and more cost-effective hardware deployment across a wide range of UE types.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

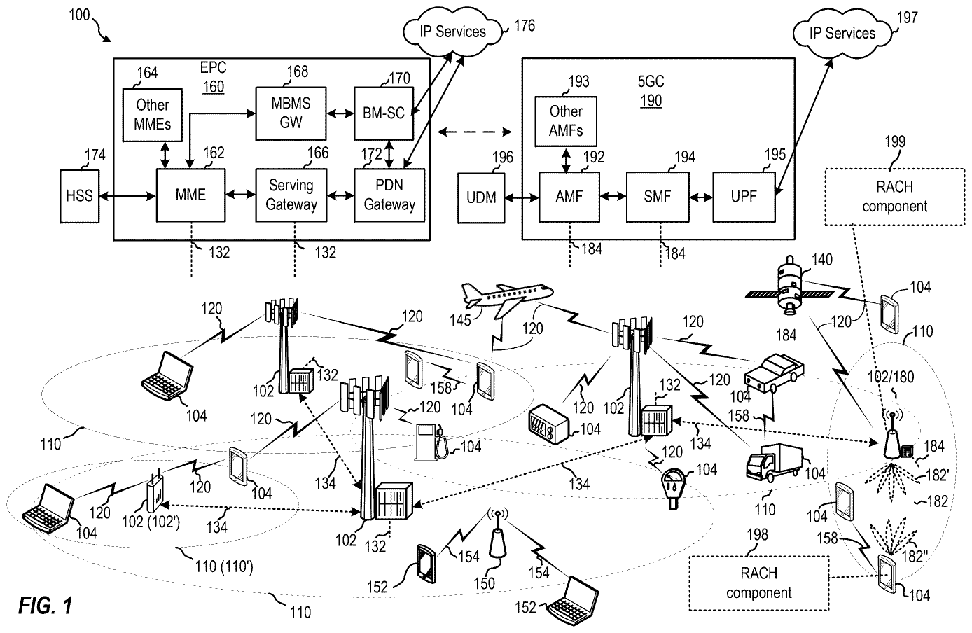

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others. UEs 104 may operate as relay devices.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

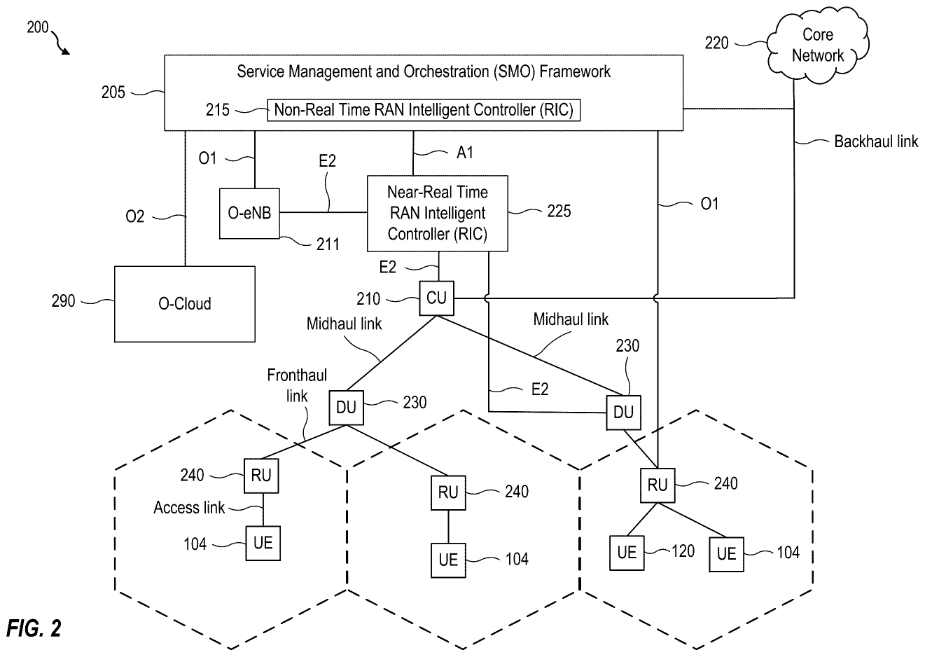

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 130) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

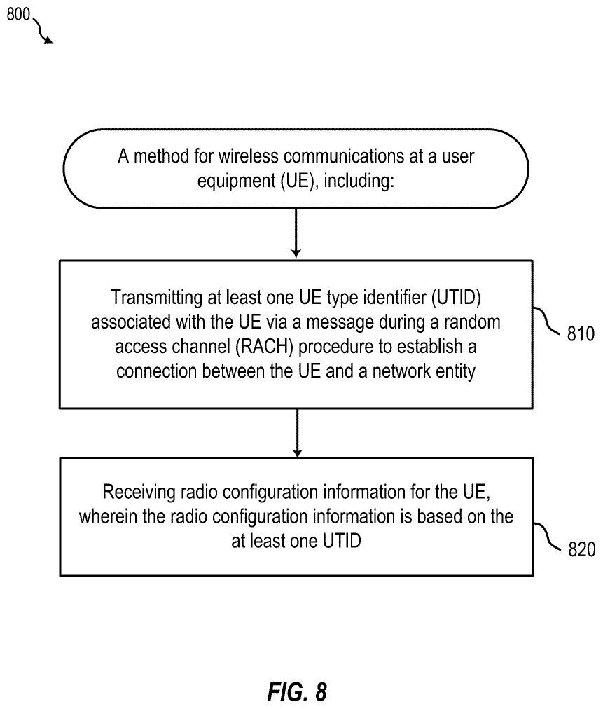

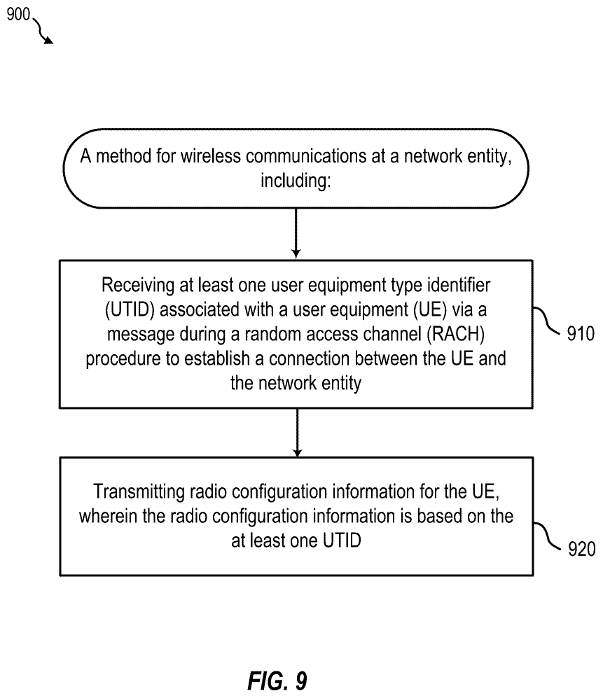

Wireless communication network 100 further includes random access channel (RACH) component 198, which may be configured to perform method 800 of FIG. 8. Wireless communication network 100 further includes RACH component 199, which may be configured to perform method 900 of FIG. 9.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

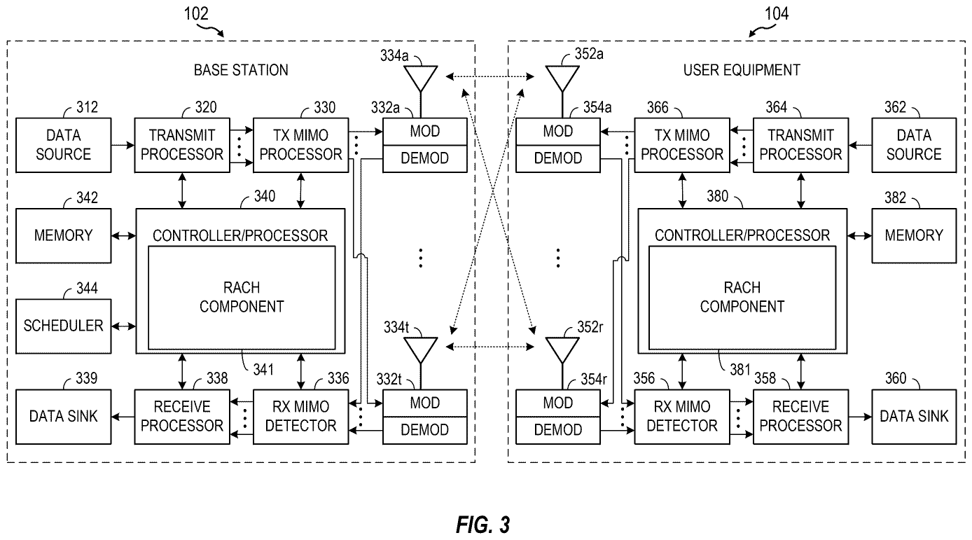

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes RACH component 341, which may be representative of RACH component 199 of FIG. 1. Notably, while depicted as an aspect of controller/processor 340, RACH component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes RACH component 381, which may be representative of RACH component 198 of FIG. 1. Notably, while depicted as an aspect of controller/processor 380, RACH component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

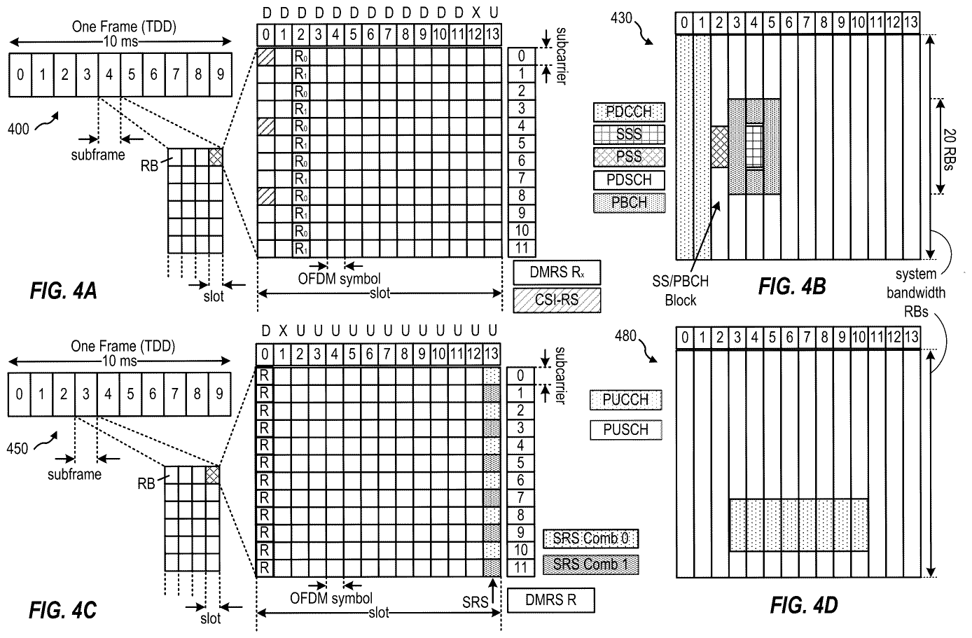

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Random Access Channel (RACH) Procedures

Random access channel (RACH) procedure is used in wireless networks to allow a user equipment (UE) to establish a connection with a base station (BS) (such as a gNodeB (gNB)) when it does not already have one. There are two types of RACH procedures: a four-step RACH procedure and a two-step RACH procedure.

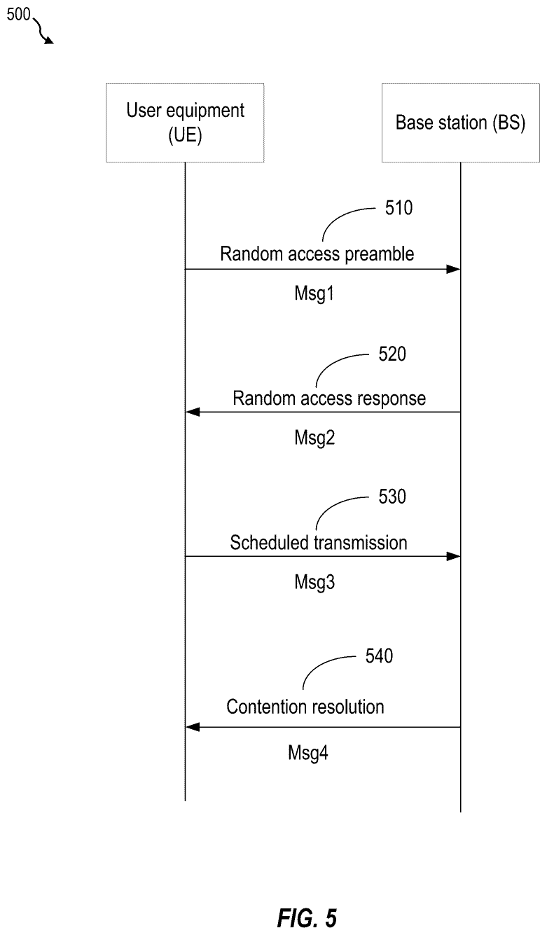

FIG. 5 illustrates a diagram 500 representing a four-step RACH procedure. The four-step RACH procedure consists of a sequence of four signaling messages exchanged between the UE and the BS.

At 510, referred to as Msg1, the UE transmits a randomly selected RACH preamble over a physical RACH (PRACH) to request network access.

At 520, referred to as Msg2, the BS responds with a random access response (RAR), which includes a timing advance command (to align transmission timing), an uplink grant (telling the UE when and where to send a next message), and/or a temporary identity (for further communication).

At 530, referred to as Msg3, the UE uses granted uplink resources to transmit a message containing its identity, such as a temporary identifier. This step may result in collisions if multiple UEs selected a same preamble.

At 540, referred to as Msg4, the BS transmits a message (such as a contention resolution message) to confirm which UE message was successfully decoded, thereby resolving any contention.

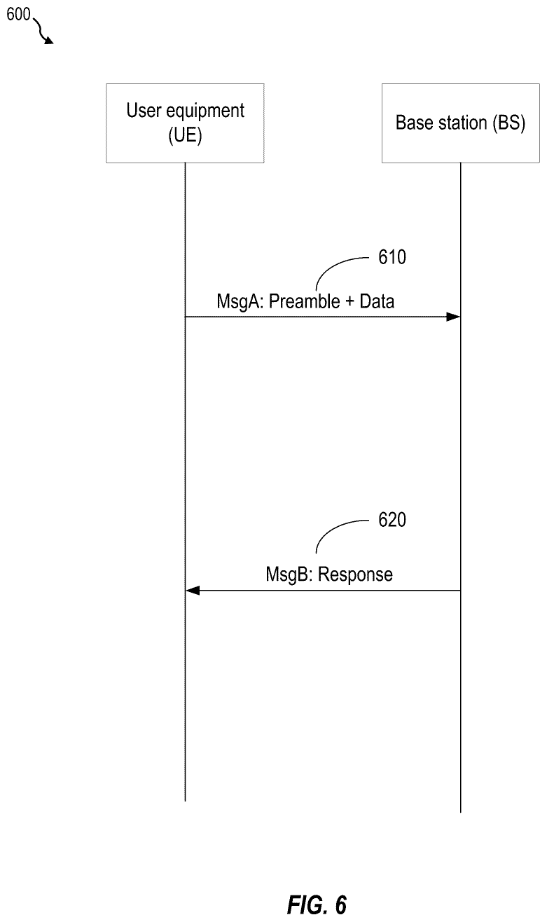

FIG. 6 illustrates a diagram 600 representing a two-step RACH procedure.

At 610, referred to as MsgA, the UE simultaneously transmits a preamble (RACH preamble) and uplink data (such as a radio resource control (RRC) setup request, or small data) using both PRACH and physical uplink shared channel (PUSCH) resources. The UE sends the data immediately, without waiting for the BS permission.

At 620, referred to as MsgB, the BS responds with MsgB, which includes a timing advance command (to help UE align with the BS time), an uplink grant confirmation (confirms that the message was received), and/or a temporary identifier (for further communication).

The two-step RACH procedure inherently reduces a total number of transmissions and minimizes access delay, making it particularly well-suited for low-latency or small data transfer scenarios, such as in ultra-reliable low-latency communications (URLLC). However, as it relies on implicit contention resolution, it is best suited for scenarios with low collision probability.

### Overview of Service Profile Identifier (SPID)

In wireless systems for 5^{th} generation (5G) services, different types of user equipments (UEs) may require different kinds of services (e.g., enhanced mobile broadband (eMBB) versus ultra-reliable low-latency communication (URLLC)). Each service type has unique requirements for a quality of service (QoS) in a core network, and also demands specific configurations of radio resources in a radio access network (RAN).

To manage this, the wireless systems may use a service profile identifier (SPID) associated with a UE. The SPID may identify what type of the UE is being used and what kind of services it requires. The SPID may be provisioned during a network deployment phase and stored in an access and mobility management function (AMF) as part of the subscriber's profile. The SPID may help a base station (BS) apply appropriate QoS policies and configure radio resources according to the needs of each UE.

The SPID may play a crucial role in enabling the BS to deliver appropriate services to the UE. The SPID may be used throughout different stages in establishing services for the UE. The different stages may include UE registration, session establishment, and service request.

For example, when a UE powers on and connects to the BS, the UE may send a registration request to the core network via the RAN. The AMF may receive this request and retrieves the SPID of the UE from a unified data management (UDM) system based on the subscriber's profile of the UE. This SPID tells the BS what services the UE is allowed to access.

Once registered, the UE may initiate a request to establish a protocol data unit (PDU) session, which is necessary for data communication. A session management function (SMF) may use the SPID to determine correct QoS parameters and policies for that session. The SMF may then interact with a policy control function (PCF) to enforce the required QoS rules and policies based on the SPID.

When the UE requests a specific service (like voice or video), the UE may send a service request to the AMF. The AMF may check the SPID to verify whether the subscriber is entitled to use the requested service. If the request is valid, the core network may notify the RAN and may include the UE SPID. The RAN may use the SPID to allocate the necessary radio resources and to establish required data radio bearers (DRBs) for the service.

6G systems are designed to support a wide variety of UE types such as an eMBB UE, a fixed wireless access (FWA) UE, an internet of thing (IoT) UE, a vehicular UE, and a reduced capability (RedCap) UE.

Different types of UEs may require specialized handling even before they establish a full connection to the BS (e.g., before reaching a resource control (RRC) connected state). For instance, FWA UEs may follow simplified random access channel (RACH) procedures compared to other UE types. Similarly, RedCap UEs may need to utilize their own dedicated RACH resources to support their lightweight and low-complexity access requirements.

Currently, the SPID associated with the UE becomes available for use at the BS only after the UE completes the RRC connection process, that is, once the UE is in the RRC connected state. Similarly, the UE capabilities, which the BS might use to infer its type, are also inaccessible prior to the RRC connection. As a result, the BS lacks early visibility into the nature of the connecting UE, limiting its ability to tailor and optimize access procedures (e.g., RACH procedures) based on the UE type.

### Aspects Related to UE Type ID for RACH Procedures

The techniques described here introduce a new user equipment type identifier (UTID), which may be linked to a user equipment (UE). This identifier may indicate a type of the UE (such as a smartphone, wearable, or other device) to a base station (BS) early in a connection process, including during initial access procedures, before a radio resource control (RRC) connection is established. By identifying the UE type upfront, the BS may tailor access handling to the specific UE type right from the start.

The UTID can be either standardized (e.g., defined within wireless communication standards) or proprietary (e.g., set by individual network operators).

This new identifier may also offer added flexibility for chipset manufacturers. For example, a single hardware (UE) design can be assigned different UTIDs for various market segments or applications. This allows manufacturers to deploy a unified chip platform across multiple products, lowering development costs and benefiting from economies of scale.

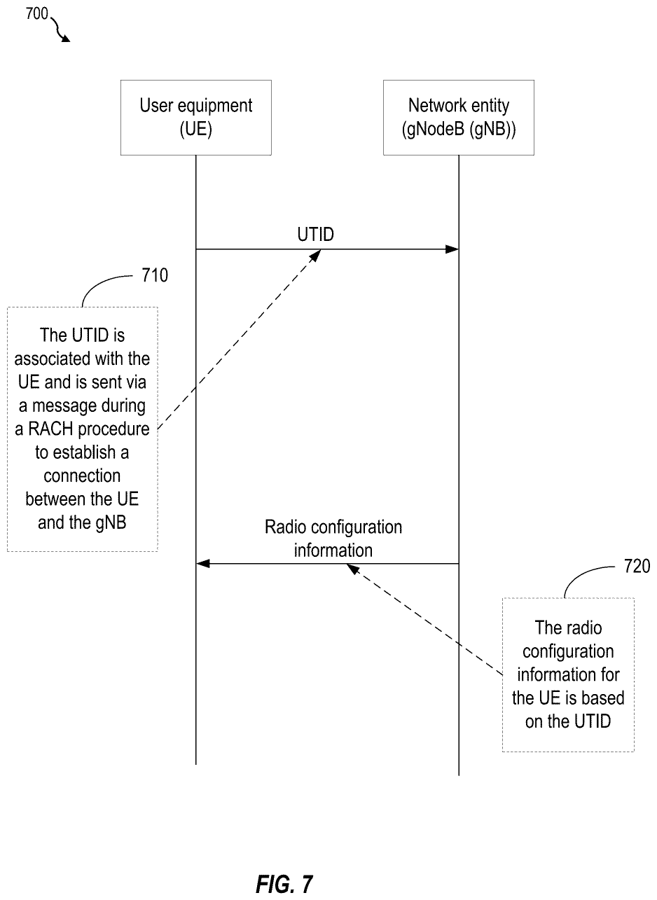

The techniques proposed herein may be further understood with reference to FIG. 7-FIG. 11.

FIG. 7 depicts a call flow diagram 700 that illustrates an example of communication between various wireless nodes such as a UE and a gNodeB (gNB).

The UE shown in FIG. 7 may be an example of the UE 104 depicted and described with respect to FIG. 1 and FIG. 3.

The gNB depicted in FIG. 7 may be an example of the BS 102 depicted and described with respect to FIG. 1 and FIG. 3, or the disaggregated BS depicted and described with respect to FIG. 2.

As indicated at 710, the UE sends a UTID associated with the UE to the gNB. The UE may send the UTID via a message during a RACH procedure, which may be to establish a connection between the UE and the gNB.

The UTID may indicate a type of the UE (e.g., a mobile phone, smart meter, or industrial sensor). The UTID may be associated with one or more services or functions (e.g., a default service) provisioned for the UE (based on the type of the UE). Each of the one or more services or functions may be associated with a different quality of service (QoS). In one example, a first type of the UE (e.g., a mobile phone) may be associated with a first set of services (e.g., voice and data services). In another example, a second type of the UE (e.g., an industrial sensor) may be associated with a second set of services (e.g., data services).

In one aspect, the RACH procedure may be a four-step RACH procedure. If the four-step RACH procedure is used, the UTID may be included in Msg3. For example, the UE may send the UTID via a connection request message, which may be used by the UE for requesting the connection with the gNB.

In another aspect, the RACH procedure may be a two-step RACH procedure. If the two-step RACH procedure is used, the UTID may be included in MsgB. For example, the UE may send the UTID via an uplink message, which may be used by the UE for carrying uplink payload.

In another aspect, when feature indication may be enabled for the RACH procedure, the UTID may be embedded in an enhanced RACH preamble of the message.

As indicated at 720, the gNB sends radio configuration information to the UE. The gNB may transmit the radio configuration information to the UE using a system information block (SIB) or via other signaling mechanisms.

The radio configuration information may be based on the UTID of the UE. For example, the radio configuration information may include frequency resources allocated for the UE based on the one or more services or functions provisioned for the UE. In another example, the radio configuration information may include time resources allocated for the UE based on the one or more services or functions provisioned for the UE. In another example, the radio configuration information may include spatial resources allocated for the UE based on the one or more services or functions provisioned for the UE.

In certain aspects, after receiving the UTID of the UE, the gNB may send a request which may also include the UTID of the UE to an access and mobility management function (AMF). The AMF may, based on the request, determine (look up) a radio access network (RAN) configuration corresponding to the UTID from a unified data management (UDM) system. For example, each UTID may be associated with a certain RAN configuration.

The AMF may, based on the request, also determine (look up) for a service profile identifier (SPID), which may be associated with the default service associated with the UTID. The SPID may indicate policies and QoS rules for the default service.

After determining the RAN configuration and/or the SPID, the AMF may communicate with a policy control function (PCF) to apply the policies and QoS rules associated with the default service.

The AMF may send the RAN configuration and/or the SPID to the gNB. The RAN configuration may indicate RAN parameters that may be based on the default service associated with the UTID and/or the policies and QoS rules associated with the default service. The RAN parameters may include radio parameters (such as frequency bands and resources, bandwidth, subcarrier spacing), QoS and scheduling information (such as resource allocation rules and QoS profiles), network topology (such as cell information), and/or access control information.

The gNB may apply the RAN configuration received from the AMF. The gNB may also apply other necessary configurations associated with the received SPID.

In some aspects, if the UE prefers a service other than the default service, the UE may initiate a procedure to establish its preferred service after completing the RRC connection with the gNB.

In certain aspects, an operator may provision associations between UTIDs and their associated eligible services (e.g., represented by SPIDs) in an AMF. Each UTID may be associated with at least one default service (e.g., voice, data, etc.) through configuration. For example, a first UTID may be associated with a first set of services (e.g., voice, data) and a second UTID may be associated with a second set of services (e.g., voice).

In certain aspects, an operator may configure associations between UTIDs and RAN configurations in the UDM. For example, a RAN configuration may serve as a default configuration for the UE type corresponding to the UTID. Additional RAN configurations may be specific to services. For example, a first RAN configuration (with a first set of RAN parameters) may be associated with a first service (e.g., voice) and/or a first UE type (e.g., smartphone). In another example, a second RAN configuration (with a second set of RAN parameters) may be associated with a second service (e.g., data) and/or a second UE type (e.g., vehicle).

The RAN configurations may aim to expedite RAN setup for a given UE type before the UE performs service establishment via non-access stratum (NAS) signaling.

In certain aspects, the gNB may include UTID-specific system information in its SIBs.

In certain aspects, a fixed wireless access (FWA) UE may have a dedicated paging control channel (PCCH) configuration, while a reduced capability (RedCap) UE may use a distinct initial bandwidth part (BWP). This may allow different UE types (such as the FWA UE and the RedCap UE) to perform idle mode procedures and initial access procedures in a differentiated manner, such as, using different initial BWPs, RACH resources, RACH procedures, and/or paging channel configurations. The gNB may enable the different UE types to perform the idle mode procedures and the initial access procedures differently.

### Example Methods for Wireless Communications

FIG. 8 shows an example of a method 800 for wireless communications at a wireless node such as a user equipment (UE). The UE may be the UE 104 of FIG. 1 and FIG. 3.

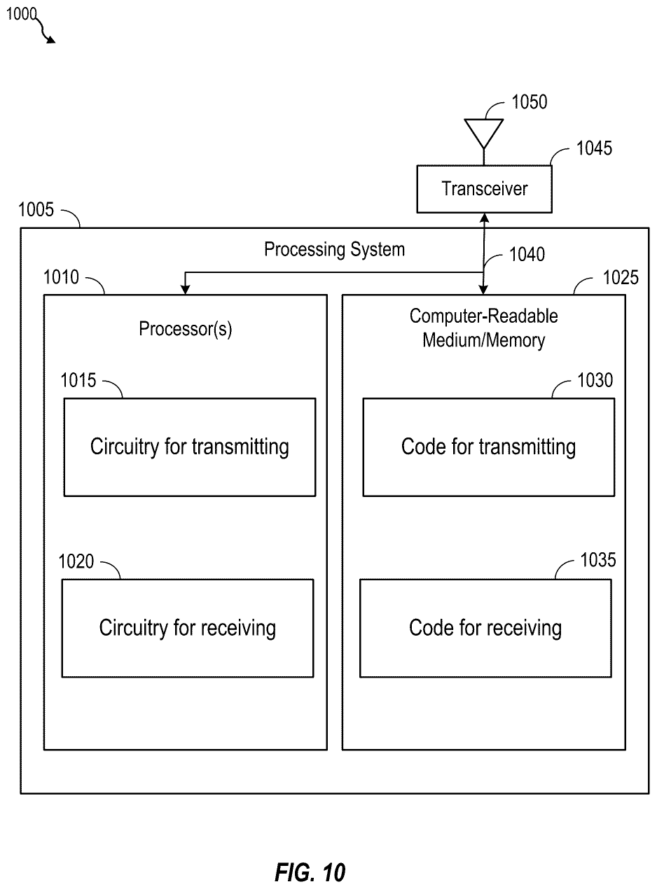

Method 800 begins at 810 with transmitting at least one UE type identifier (UTID) associated with the UE via a message during a random access channel (RACH) procedure to establish a connection between the UE and a network entity. In some cases, the operations of this step refer to, or may be performed by, circuitry for transmitting and/or code for transmitting as described with reference to FIG. 10.

Method 800 then proceeds to 820 with receiving radio configuration information for the UE. The radio configuration information is based on the at least one UTID. In some cases, the operations of this step refer to, or may be performed by, circuitry for receiving and/or code for receiving as described with reference to FIG. 10.

In certain aspects, the radio configuration information includes at least one of: frequency resources, time resources, or spatial resources allocated for the UE.

In certain aspects, the at least one UTID of the UE is associated with one or more services or functions provisioned for the UE, and each of the one or more services or functions is associated with a different quality of service (QoS).

In certain aspects, the RACH procedure is a four-step RACH procedure, and the message is a connection request message used for requesting the connection with the network entity during the four-step RACH procedure.

In certain aspects, the RACH procedure is a two-step RACH procedure, and the message is an uplink message used for carrying uplink payload during the two-step RACH procedure.

In certain aspects, the radio configuration information is received via a system information block (SIB).

In one aspect, the method 800, or any aspect related to it, may be performed by an apparatus, such as a wireless node 1000 of FIG. 10, which includes various components operable, configured, or adapted to perform the method 800. The wireless node 1000 is described below in further detail.

Note that FIG. 8 is just one example of a method, and other methods including fewer, additional, or alternative steps are possible consistent with this disclosure.

FIG. 9 shows an example of a method 900 for wireless communications at a wireless node such as a network entity. The network entity may be the 5GC 190 of FIG. 1, or the BS 102 of FIG. 1 and FIG. 3.

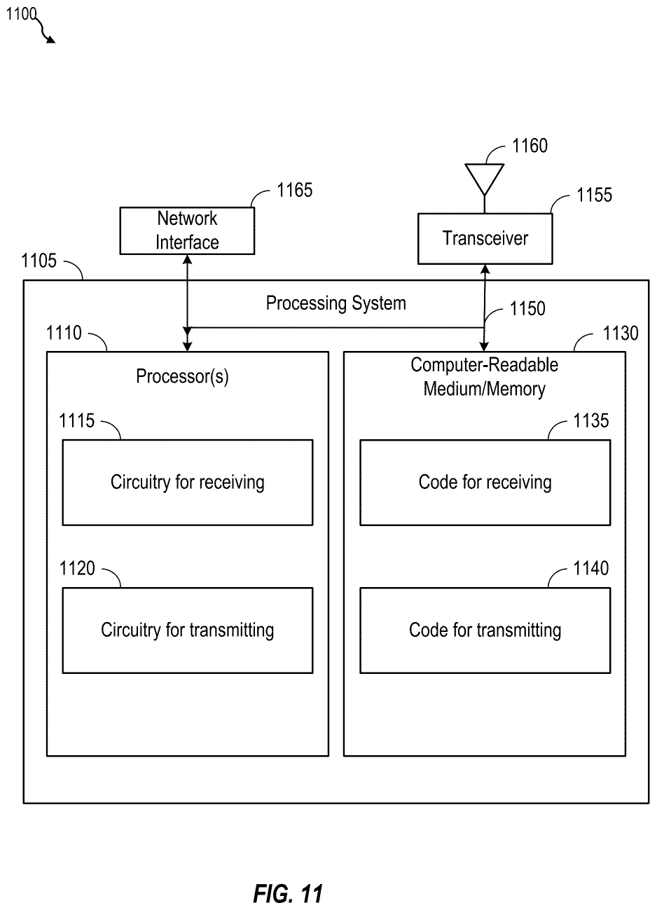

Method 900 begins at 910 with receiving at least one UTID associated with a UE via a message during a RACH procedure to establish a connection between the UE and the network entity. In some cases, the operations of this step refer to, or may be performed by, circuitry for receiving and/or code for receiving as described with reference to FIG. 11.

Method 900 then proceeds to 920 with transmitting radio configuration information for the UE. The radio configuration information is based on the at least one UTID. In some cases, the operations of this step refer to, or may be performed by, circuitry for transmitting and/or code for transmitting as described with reference to FIG. 11.

In certain aspects, the radio configuration information includes at least one of: frequency resources, time resources, or spatial resources allocated for the UE.

In certain aspects, the at least one UTID of the UE is associated with one or more services or functions provisioned for the UE, and each of the one or more services or functions is associated with a different QoS.

In certain aspects, the method 900 further includes transmitting an indication of the at least one UTID of the UE to an access and mobility management function (AMF). The method 900 further includes receiving from the AMF at least one of: a radio access network (RAN) configuration for the UE or a service profile ID (SPID) of the UE, wherein at least one of the RAN configuration or the SPID is associated with the at least one UTID.

In certain aspects, the SPID indicates one or more services or functions associated with the UE.

In certain aspects, the RAN configuration indicates radio resources allocated for the UE based on the one or more services or functions associated with the UE, and the radio resources include at least one of: frequency resources, time resources, or spatial resources.

In certain aspects, the radio configuration information is transmitted via a SIB.

In one aspect, the method 900, or any aspect related to it, may be performed by an apparatus, such as a wireless node 1100 of FIG. 11, which includes various components operable, configured, or adapted to perform the method 900. The wireless node 1100 is described below in further detail.

Note that FIG. 9 is just one example of a method, and other methods including fewer, additional, or alternative steps are possible consistent with this disclosure.

### Example Wireless Nodes

FIG. 10 depicts aspects of an example wireless node 1000. The wireless node 1000 may be a user equipment (UE), such as the UE 104 described above with respect to FIG. 1 and FIG. 3.

The wireless node 1000 includes a processing system 1005 coupled to a transceiver 1045 (e.g., a transmitter and/or a receiver). The transceiver 1045 is configured to transmit and receive signals for the wireless node 1000 via an antenna 1050, such as the various signals as described herein. The processing system 1005 may be configured to perform processing functions for the wireless node 1000, including processing signals received and/or to be transmitted by the wireless node 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1025 via a bus 1040. In certain aspects, the computer-readable medium/memory 1025 is configured to store instructions (e.g., computer-executable code) that when executed by the one or more processors 1010, cause the one or more processors 1010 to perform the method 800 described with respect to FIG. 8, and/or any aspect related to it. Note that reference to a processor performing a function of the wireless node 1000 may include the one or more processors 1010 performing that function of the wireless node 1000.

In the depicted example, computer-readable medium/memory 1025 stores code (e.g., executable instructions), such as code for transmitting 1030 and code for receiving 1035. Processing of the code for transmitting 1030 and the code for receiving 1035 may cause the wireless node 1000 to perform the method 800 described with respect to FIG. 8, and/or any aspect related to it.

The one or more processors 1010 include circuitry configured to implement (e.g., execute) the code stored in the computer-readable medium/memory 1025, including circuitry such as circuitry for transmitting 1015 and circuitry for receiving 1020. Processing with the circuitry for transmitting 1015 and the circuitry for receiving 1020 may cause the wireless node 1000 to perform the method 800 described with respect to FIG. 8, and/or any aspect related to it.

Various components of the wireless node 1000 may provide means for performing the method 800 described with respect to FIG. 8, and/or any aspect related to it. For example, means for transmitting, sending or outputting (e.g., for transmission) may include transceivers 354 and/or antenna(s) 352 of the UE 104 illustrated in FIG. 3 and/or the code for transmitting 1030, the circuitry for transmitting 1015, the transceiver 1045 and the antenna 1050 of the wireless node 1000 in FIG. 10. Means for receiving or obtaining may include transceivers 354 and/or antenna(s) 352 of the UE 104 illustrated in FIG. 3 and/or the code for receiving 1035, the circuitry for receiving 1020, the transceiver 1045 and the antenna 1050 of the wireless node 1000 in FIG. 10.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive multiple-input and multiple-output (MIMO) processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 100 is an example, and many other examples and configurations of the wireless node 1000 are possible.

FIG. 11 depicts aspects of an example wireless node 1100. The wireless node 1100 may be a network entity, such as the 5GC 190 of FIG. 1, or the BS 102 of FIG. 1 and FIG. 3.

The wireless node 1100 includes a processing system 1105 coupled to a transceiver 1155 (e.g., a transmitter and/or a receiver) and/or a network interface 1165. The transceiver 1155 is configured to transmit and receive signals for the wireless node 1100 via an antenna 1160, such as the various signals as described herein. The network interface 1165 is configured to obtain and send signals for the wireless node 1100 via communication link(s), such as a backhaul link, midhaul link, and/or fronthaul link as described herein, such as with respect to FIG. 2. The processing system 1105 may be configured to perform processing functions for the wireless node 1100, including processing signals received and/or to be transmitted by the wireless node 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 900 described with respect to FIG. 9, or any aspect related to it. Note that reference to a processor of the wireless node 1100 performing a function may include the one or more processors 1110 of the wireless node 1100 performing that function.

In the depicted example, the computer-readable medium/memory 1130 stores code (e.g., executable instructions), such as code for receiving (or obtaining) 1135 and code for transmitting (or outputting) 1140. Processing of the code for receiving 1135 and the code for transmitting 1140 may cause the wireless node 1100 to perform the method 900 described with respect to FIG. 9, or any aspect related to it.

The one or more processors 1110 include circuitry configured to implement (e.g., execute) the code stored in the computer-readable medium/memory 1130, including circuitry such as circuitry for receiving (or obtaining) 1115 and circuitry for transmitting (or outputting) 1120. Processing with the circuitry for receiving 1115 and the circuitry for transmitting 1120 may cause the wireless node 1100 to perform the method 900 described with respect to FIG. 9, or any aspect related to it.

Various components of the wireless node 1100 may provide means for performing the method 900 described with respect to FIG. 9, or any aspect related to it. Means for transmitting, sending or outputting for transmission may include transceivers 332 and/or antenna(s) 334 of the BS 102 illustrated in FIG. 3 and/or the circuitry for transmitting 1120, the code for transmitting 1140, the transceiver 1155 and the antenna 1160 of the wireless node 1100 in FIG. 11. Means for receiving or obtaining may include transceivers 332 and/or antenna(s) 334 of the BS 102 illustrated in FIG. 3 and/or the circuitry for receiving 1115, the code for receiving 1135, the transceiver 1155 and the antenna 1160 of the wireless node 1100 in FIG. 11.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 11 is an example, and many other examples and configurations of the wireless node 1100 are possible.

### Example Clauses

Implementation examples are described in the following numbered clauses:

Clause 1: A method for wireless communications at a user equipment (UE), comprising: transmitting at least one UE type identifier (UTID) associated with the UE via a message during a random access channel (RACH) procedure to establish a connection between the UE and a network entity; and receiving radio configuration information for the UE, wherein the radio configuration information is based on the at least one UTID.

Clause 2: The method of clause 1, wherein the radio configuration information comprises at least one of: frequency resources, time resources, or spatial resources allocated for the UE.

Clause 3: The method of any one of clauses 1-2, wherein: the at least one UTID of the UE is associated with one or more services or functions provisioned for the UE; and each of the one or more services or functions is associated with a different quality of service (QoS).

Clause 4: The method of any one of clauses 1-3, wherein: the RACH procedure is a four-step RACH procedure; and the message is a connection request message used for requesting the connection with the network entity during the four-step RACH procedure.

Clause 5: The method of any one of clauses 1-4, wherein: the RACH procedure is a two-step RACH procedure; and the message is an uplink message used for carrying uplink payload during the two-step RACH procedure.

Clause 6: The method of any one of clauses 1-5, wherein the radio configuration information is received via a system information block (SIB).

Clause 7: A method for wireless communications at a network entity, comprising: receiving at least one user equipment type identifier (UTID) associated with a user equipment (UE) via a message during a random access channel (RACH) procedure to establish a connection between the UE and the network entity; and transmitting radio configuration information for the UE, wherein the radio configuration information is based on the at least one UTID.

Clause 8: The method of clause 7, wherein the radio configuration information comprises at least one of: frequency resources, time resources, or spatial resources allocated for the UE.

Clause 9: The method of any one of clauses 7-8, wherein: the at least one UTID of the UE is associated with one or more services or functions provisioned for the UE; and each of the one or more services or functions is associated with a different quality of service (QoS).

Clause 10: The method of any one of clauses 7-9, further comprising: transmitting an indication of the at least one UTID of the UE to an access and mobility management function (AMF); and receiving from the AMF at least one of: a radio access network (RAN) configuration for the UE or a service profile ID (SPID) of the UE, wherein at least one of the RAN configuration or the SPID is associated with the at least one UTID.

Clause 11: The method of clause 10, wherein the SPID indicates one or more services or functions associated with the UE.

Clause 12: The method of clause 11, wherein the RAN configuration indicates radio resources allocated for the UE based on the one or more services or functions associated with the UE, and wherein the radio resources comprise at least one of: frequency resources, time resources, or spatial resources.

Clause 13: The method of any one of clauses 7-12, wherein the radio configuration information is transmitted via a system information block (SIB).

Clause 14: An apparatus, including: at least one memory including instructions; and one or more processors configured, individually or in any combination, to execute the instructions and cause the apparatus to perform a method in accordance with any one of Clauses 1-13.

Clause 15: An apparatus, including means for performing a method in accordance with any one of Clauses 1-13.

Clause 16: A non-transitory computer-readable medium including executable instructions that, when executed by one or more processors of an apparatus, cause the apparatus to perform a method in accordance with any one of Clauses 1-13.

Clause 17: A computer program product embodied on a computer-readable storage medium including code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors, individually or collectively, configured to execute the instructions and cause the apparatus to:
transmit at least one UE type identifier (UTID) associated with the UE via a message during a random access channel (RACH) procedure to establish a connection between the UE and a network entity; and
receive radio configuration information for the UE, wherein the radio configuration information is based on the at least one UTID.

2. The apparatus of claim 1, wherein the radio configuration information comprises at least one of: frequency resources, time resources, or spatial resources allocated for the UE.

3. The apparatus of claim 1, wherein:
the at least one UTID of the UE is associated with one or more services or functions provisioned for the UE; and
each of the one or more services or functions is associated with a different quality of service (QoS).

4. The apparatus of claim 1, wherein:
the RACH procedure is a four-step RACH procedure; and
the message is a connection request message used for requesting the connection with the network entity during the four-step RACH procedure.

5. The apparatus of claim 1, wherein:
the RACH procedure is a two-step RACH procedure; and
the message is an uplink message used for carrying uplink payload during the two-step RACH procedure.

6. The apparatus of claim 1, wherein the radio configuration information is received via a system information block (SIB).

7. An apparatus for wireless communications at a network entity, comprising:
at least one memory comprising instructions; and
one or more processors, individually or collectively, configured to execute the instructions and cause the apparatus to:
receive at least one user equipment type identifier (UTID) associated with a user equipment (UE) via a message during a random access channel (RACH) procedure to establish a connection between the UE and the network entity; and
transmit radio configuration information for the UE, wherein the radio configuration information is based on the at least one UTID.

8. The apparatus of claim 7, wherein the radio configuration information comprises at least one of: frequency resources, time resources, or spatial resources allocated for the UE.

9. The apparatus of claim 7, wherein:
the at least one UTID of the UE is associated with one or more services or functions provisioned for the UE; and
each of the one or more services or functions is associated with a different quality of service (QoS).

10. The apparatus of claim 7, wherein the one or more processors, individually or collectively, are configured to execute the instructions and cause the apparatus to:
transmit an indication of the at least one UTID of the UE to an access and mobility management function (AMF); and
receive from the AMF at least one of: a radio access network (RAN) configuration for the UE or a service profile ID (SPID) of the UE, wherein at least one of the RAN configuration or the SPID is associated with the at least one UTID.

11. The apparatus of claim 10, wherein the SPID indicates one or more services or functions associated with the UE.

12. The apparatus of claim 11, wherein the RAN configuration indicates radio resources allocated for the UE based on the one or more services or functions associated with the UE, and wherein the radio resources comprise at least one of: frequency resources, time resources, or spatial resources.

13. The apparatus of claim 7, wherein the radio configuration information is transmitted via a system information block (SIB).

14. A method for wireless communications at a user equipment (UE), comprising:
transmitting at least one UE type identifier (UTID) associated with the UE via a message during a random access channel (RACH) procedure to establish a connection between the UE and a network entity; and
receiving radio configuration information for the UE, wherein the radio configuration information is based on the at least one UTID.

15. The method of claim 14, wherein the radio configuration information comprises at least one of: frequency resources, time resources, or spatial resources allocated for the UE.

16. The method of claim 14, wherein the at least one UTID of the UE is associated with one or more services or functions provisioned for the UE.

17. The method of claim 16, wherein each of the one or more services or functions is associated with a different quality of service (QoS).

18. The method of claim 14, wherein:
the RACH procedure is a four-step RACH procedure; and
the message is a connection request message used for requesting the connection with the network entity during the four-step RACH procedure.

19. The method of claim 14, wherein:
the RACH procedure is a two-step RACH procedure; and
the message is an uplink message used for carrying uplink payload during the two-step RACH procedure.

20. The method of claim 14, wherein the radio configuration information is received via a system information block (SIB).
